(19) United States
(12) Patent Application Publication
(10) Pub. No.: US 2014/0260714 A1
(43) Pub. Date: Sep. 18, 2014

(54) GYROSCOPIC-ASSISTED DEVICE TO CONTROL BALANCE

(71) Applicant: Khalifa University of Science, Technology & Research (KUSTAR), (US)

(72) Inventors: HEIKE VALLERY, Abu Dhabi (AE); DUSTIN JUHN-YIN LI, Abu Dhabi (AE)

(73) Assignee: Khalifa University of Science, Technology & Research (KUSTAR), Abu Dhabi (AE)

(21) Appl. No.: 13/803,902

(22) Filed: Mar. 14, 2013

(51) Int. Cl. G01C 19/04

(52) U.S. Cl. CPC G01C 19/04
USPC 74/5.37

(57) ABSTRACT

The embodiment herein generally relates to a system to apply moments to a user, particularly during gait. The system is a portable gyroscopic-assisted system, mounted on a user's body, particularly the upper body, particularly to influence orientation of users having difficulty with balancing during gait. The system comprises a plurality of variable-speed control moment gyroscopes (VSCMGs). The VSCMGs generate moments, particularly to counteract a fall to any direction. The VSCMGs are placed close to the center of mass of the user. The couple moments of the VSCMGs are transmitted to the user through a support structure that is tightly attached to the user. Particularly, the system controls moments based on detecting pre-fall conditions.

### CROSS-REFERENCE TO RELATED APPLICATION

This application claims the benefit of priority to U.S. provisional patent application Ser. No. 61/611,160, filed on Mar. 15, 2012, the disclosure of which is incorporated herein by reference.

### BACKGROUND

1. Technical Field

The embodiments herein generally relate to a balance assistance device and particularly relate to a system for applying moments to the body of a user, particularly for balancing or recovering balance during bipedal gait. The embodiments herein more particularly relate to a gyroscopic-assisted device for balancing a user during bipedal gait. The term “user” includes a human, animal, or robot, particularly patients with neurological or orthopedic impairments, astronauts, divers, soldiers, and athletes.

2. Description of the Related Art

A common problem in aging societies arises from neuromuscular deficits that lead to a higher risk of falls for an individual. Falling is the most frequent cause of injury among elderly people. Increased risk of falling is not just confined to the elderly, but also to people suffering from diseases like stroke or spinal cord injury. Efforts have been made in creating devices that assist in locomotion. However, currently available robotic technology aims at providing versatile functionality, for example to compensate both neurological impairments as well as muscle weakness. Such a versatile design leads to a development of heavy and bulky devices that are impractical for use in daily life for many users.

The prevention and the reduction of the frequency of falling events in aging societies is an urgent challenge, as they are the most frequent causes of hospitalization. Apart from muscle weakness, a key factor leading to falling is degraded balance control capability. Humans use multiple strategies to maintain balance during standing and during locomotion. The “ankle strategy” moves the Zero Moment Point (ZMP), which is the point where the line of action of the ground reaction force intersects with the ground. The “hip strategy” moves the upper body in an opposite direction with respect to a lower body, thereby effectively changing total angular momentum of the body. The ankle and hip strategies are dominant during stance. The strategy that is predominantly used for balance control during locomotion is to adjust placement of a foot. The arms also play a role in maintaining balance during gait (particularly in balance recovery) by changing angular momentum. A cooperative robotic support system generally should not override these control strategies because the user would adapt to the robotic support and increasingly rely on it, which is undesirable for rehabilitation. To avoid such maladaptation, a device should only assist as needed to provide only the support that is necessary to fulfill a task, such as recovering balance during a falling event.

Several hardware solutions for providing assistance for balancing during falling are discussed in previously published literature. The robotic device could simply be connected to an inertial frame, as disclosed in training devices like the KineAssist, the LOPES, or training devices for standing. Such a mechanical connection/coupling to the inertial frame allows the device to generate arbitrary external forces to assist the subject. However, such devices are not practical for everyday use because they have a very limited range.

Portable solutions for locomotion assistance include powered exoskeletons, which can influence the movement of individual joints. In doing so, the devices can reinforce the ankle or the hip strategy or assist in proper foot placement, thereby improving balance. However, most of the available exoskeletons, like the eLEGS (Ekso Bionics, US), or the ReWalk (Argo Medical Technologies, Israel), are designed to be strong enough to move the legs of paraplegics, thereby making the devices bulky, heavy, and complicated for normal use. Most existing research has focused on exoskeletons, which are often bulky, have a limited battery life, are difficult to wear and remove, and are very costly, thus limiting their applicability in practical use. Furthermore, such exoskeletons are not primarily designed to assist balance and can even require crutches for use. Like canes and walkers, these solutions are not suitable for people with limited strength in their upper extremities and handheld devices can even interfere with balance in some situations. Moreover, chronic use of these devices can cause repetitive stress, resulting in discomfort, pain and injury. In order to make an assistive robotic device that is acceptable to many patients, it must be unobtrusive, effective, convenient and flexible.

While the general feasibility of a gyroscope-based balance assistance system has already been investigated for bipedal robots, the control moment gyroscope (CMG) effect of only a single gyroscope was used in that study, thereby limiting its region of effectiveness. In order to react flexibly to falling in any direction while avoiding singularities, an assembly of variable-speed control moment gyroscopes (VSCMGs) is used in the embodiments herein.

The idea of using a variable-speed control moment gyroscope (VSCMG) to control the attitude of satellites has been well developed. However, the concept has not been extended to a reorientation of users or to provide balance assistance.

One of the prior arts discloses a stabilization of bipedal gait using a single gyroscope of a fixed speed to assist balance in a limited range of directions only. The prior art was primarily focused on gait in robots.

Another prior art provides a system and method for improving the balance of a user while standing or walking with support. The support comprises gyrostabilizers housed inside a cane/crutch or belt. The prior art system discloses the use of gyrostabilizers to improve the balance of users but does not actuate the gimbals of the gyroscopes. Also, the prior art system cannot return a subject to an upright position. The system can only provide a passive moment resulting from the precession or nutation of the gyroscope and it does not have actuated gimbals.

Yet another prior art provides a balance training apparatus to be attached to a bicycle for training a rider. The apparatus has a pair of flywheels attached to the axis of the rear wheel, which create a gyroscopic effect to provide stability when the bicycle is ridden. In the apparatus, the gyroscopic effect is utilized only for balancing the bicycle, and is not applied to directly stabilize users. The apparatus uses mechanisms to simply increase angular momentum rather than utilizing precession to maximize moment.

Yet other prior arts (U.S. Pat. No. 7,314,225 and U.S. Pat. No. 7,597,337) provide a “System for providing gyroscopic stabilization to a two-wheeled vehicle”. The systems only can be applied to the steerable front wheels of a variety of two-wheeled vehicles. However, both systems fail to remedy a need for a balance assistance device and a system for applying moments to the body of a user as disclosed in the present invention.

Another prior art discloses an appliance such as a two-legged robot stabilized by a gyroscope. This prior art is exclusively related to robots and does not explain gyroscopic control for users other than robots. Furthermore, this approach only employs a single gyroscope.

Another prior art provides a system to influence human balance while standing or walking. The system comprises a flywheel with the spin axis aligned with the anterior-posterior axis of the human. The flywheel is attached to the human body at the back by means of a corset. Because there is only one flywheel and no gimbal, the system cannot control the direction of the moment vector, and it cannot prevent undesired interaction moments in reaction to human movement.

Hence, there is a need for lightweight and portable active balance prostheses employing gyroscopes that are optimized for daily use. Further, there is a need for an unobtrusive, effective, convenient and flexibly wearable balance-assisting system for practical use by those who have difficulty with balance, especially for patients with neuromuscular impairments. Furthermore, there is a need for a gyroscopic-assisted system to augment the natural abilities of able-bodied persons in challenging environments.

The abovementioned shortcomings, disadvantages and problems are addressed herein and will be understood by reading and studying the following specifications.

### OBJECT OF THE EMBODIMENTS

The primary object of the embodiments herein is to provide a gyroscopic-assisted system and method for balancing a user during gait dysfunction and preventing/mitigating a fall among the elderly as well as patients suffering from neuromuscular disorders.

Another object of the embodiments herein is to provide a gyroscopic-assisted system with a lightweight backpack harness for preventing a fall of a user in any direction.

Yet another object of the embodiments herein is to develop a gyroscopic-assisted system incorporated in another user rehabilitation device, such as an exoskeleton, in order to provide a prosthesis for a paralyzed or paretic user.

Yet another object of the embodiments herein is to develop a gyroscopic-assisted system to slow down a fall or to reorient a person to a desired state (for example, a vertical position) upon detecting a fall toward any direction, with the detection particularly being based on inclination, or on rotational or translational velocity or acceleration of body parts, particularly of the trunk.

Yet another object of the embodiments herein is to develop a gyroscopic-assisted system containing gyroscopes, particularly variable-speed control moment gyroscopes (VSCMGs), as means to achieve the desired control of the imbalance.

These and other objects and advantages of the embodiments herein will become readily apparent from the following detailed description taken in conjunction with the accompanying drawings.

### SUMMARY

The embodiments herein generally relate to a portable gyroscopic-assisted system for balance. According to an embodiment herein, the system comprises a plurality of variable-speed control moment gyroscopes (VSCMGs) attached to a user body, particularly to transmit a control moment, particularly to prevent a fall of a user, particularly by slowing down the movement of the body or by bringing it to a desired orientation, particularly an upright posture. Each VSCMG is placed close to the user's center of mass, particularly with at least one spin axis oriented so that the resultant control moment that acts on the body acts about an axis about an axis in a horizontal plane is applied on the user body.

According to one embodiment herein, a removable support structure, particularly a back-frame or backpack, is attached to the back of the user or an exoskeleton to support the plurality of VSCMGs.

According to one embodiment herein, at least one actuated gimbal and one actuated spin rotor are provided for each of the plurality of the VSCMGs. Particularly, at least one gimbal axis is aligned with the longitudinal axis of the user's body. Particularly, at least one gimbal axis is oriented and controlled so as to prevent undesired gyroscopic effects. The plurality of gimbal and the spin rotors are activated to produce control moments on the user's body, particularly to prevent a fall, particularly by slowing down the fall or by bringing the body back to an upright posture.

According to one embodiment herein, the portable gyroscopic-assisted system further comprises a plurality of sensors particularly to detect a pre-fall condition of the user in order to control the gimbal and/or the spin rotor to produce the control moments required to prevent a fall, particularly to slow down a fall or to reach a desired state, particularly an uprightposture.

According to one embodiment herein, the portable gyroscopic-assisted system further comprises a means to provide electrical power to the gyroscopes, particularly by allowing connection to an external power outlet or socket and/or by means of an internal power source, particularly to supply electrical power to the plurality of VSCMGs, and/or a means of harvesting energy from the user. Particularly, the internal power source is a rechargeable battery.

According to one embodiment herein, the portable gyroscopic-assisted system further comprises a plurality of flywheels, particularly two or three. By rotating about a gimbal, the spin axes of the flywheels are varied to produce a moment, whereby particularly the rotation speed of each flywheel is controlled by a motor on the gimbal.

According to one embodiment herein, the flywheel is used as a reaction wheel to produce a moment by means of the reaction wheel effect. The reaction wheel works on the principle of conservation of angular momentum and the reaction wheel is a spinning mass with a substantial amount of inertia.

According to one embodiment herein, the portable gyroscopic-assisted system further comprises a means for braking the flywheel spinning motion, particularly by regenerative braking, particularly by means of a plurality of regenerative brakes that are connected to the flywheel spin axes. This braking function can also be realized by the motors that actuate the flywheel. The brakes generate moments on the user and convert kinetic energy stored in the flywheels into electrical energy. Particularly, this electrical energy is used immediately by the gyroscopic-assisted system, and/or it is stored in an additional means for energy storage, particularly a battery or capacitor.

According to one embodiment herein, the portable gyroscopic-assisted system further comprises a controller for tracking a reference moment, particularly in a transverse plane, by using the plurality of the VSCMGs. Particularly, the controller tracks the reference moment by using the reaction wheel effect and/or the gyroscopic effect, particularly by following an optimization procedure.

According to one embodiment herein, the portable gyroscopic-assisted system further comprises a plurality of Direct Current (DC) motors. The plurality of the DC motors—in combination with a plurality of planetary gears—controls speed and torque for the plurality of the VSCMGs.

According to one embodiment herein, a method for stabilizing bipedal gait with gyroscopic assistance is provided. The method comprises the steps of attaching a back frame, particularly a rigid or flexible back frame, to the back of a user. The support structure comprises a plurality of VSCMGs, with at least one actuated gimbal, one flywheel, and potentially one spin motor to actuate the flywheel arranged corresponding to each of the plurality of the VSCMGs, and a plurality of sensors for measuring the current movement of the user, particularly for detecting a fall condition. The plurality of VSCMGs generates moments in order to produce a resultant control moment on the user, particularly to counteract a fall of the user. Particularly, a controlling device provides control signals for the motors, particularly for generating moments by means of the plurality of VSCMGs, particularly when a loss of balance is detected. Particularly, these control signals can be based on a model of a falling user, particularly to bring the user to a desired configuration. Particularly, the final configuration is defined as one in which the user is oriented vertically, particularly with zero velocity.

According to one embodiment herein, the control signals generate a moment vector that lies in the transverse plane of the user to counteract a tilt of the user about a horizontal axis.

According to one embodiment herein, a reaction wheel mode is exploited to compensate for errors instantaneously in the transverse plane.

According to one embodiment herein, the speed of the gimbals is forced to zero when the flywheels approach an undesired configuration, particularly a singular configuration where the spin axis is aligned with the required moment.

According to one embodiment herein, the speed of the gimbals is forced to zero to nullify a plurality of oscillations around the singular configuration.

According to one embodiment herein, the plurality of VSCMGs tracks a desired (reference) moment profile, particularly distributed among the plurality of VSCMGs by means of an optimization process, particularly to gently upright the user.

According to one embodiment herein, the optimization process automatically exploits the reaction wheel effect and/or the gyroscopic effect of the plurality of the VSCMGs.

According to one embodiment herein, a fall detection algorithm is provided, where particularly the fall detection algorithm is based on sensor measurements of the current user motion, particularly of the upper body, particularly measured by inertial, gyroscopic, or magnetic sensors.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a schematic design of a portable gyroscopic-assisted system worn by a user, according to one embodiment herein.

FIG. 2 illustrates the axes and Euler angle definitions for the various directions and associated with the axis of an inertial frame and the axes of a local coordinate system fixed to the trunk of the user according to one embodiment herein. The user tilts about the y′ axis.

FIG. 3 illustrates a perspective view of a VSCMG used in a portable gyroscopic-assisted system, as well as the local coordinate system that is fixed to the trunk of the user and the local coordinate system that is fixed to the VSCMG, according to one embodiment herein.

FIG. 4 illustrates a chart indicating the spin and gimbal actuator torques generated in a simulation of a portable gyroscopic-assisted system, according to one embodiment herein.

FIG. 5 illustrates a chart indicating reference and actual moment components in a simulation of a portable gyroscopic-assisted system, according to one embodiment herein. Reference and actual moment almost coincide due to the control strategy, and only the moment component about the user's tilting axis (the y′ axis) is nonzero.

FIG. 6 illustrates a chart indicating spin and gimbal actuator power generated in a simulation of a portable gyroscopic-assisted system, according to one embodiment herein.

FIG. 7 illustrates a chart indicating gimbal angles generated in a simulation of a portable gyroscopic-assisted system, according to one embodiment herein.

FIG. 8 illustrates a chart indicating spinning speeds in a simulation of a portable gyroscopic-assisted system, according to one embodiment herein.

FIG. 9 illustrates a chart indicating speed of user motion generated in a simulation of a portable gyroscopic-assisted system, expressed in modified Rodrigues parameters (MRPs), according to one embodiment herein.

FIG. 10 illustrates a cross-section perspective view of a VSCMG in a portable gyroscopic-assisted system, according to one embodiment herein.

Although the specific features of the embodiments herein are shown in some drawings and not in others, this is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced are shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein generally relate to a portable gyroscopic-assisted system, particularly for balance. According to an embodiment herein, the system comprises a plurality of VSCMGs attached to a user, particularly to transmit a control moment, particularly to prevent a fall, particularly by slowing down the movement of the body or by bringing it to a desired configuration, particularly an upright posture. The plurality of VSCMGs is placed close to the user's center of mass, particularly with at least one gimbal axis oriented so the resultant control moment that acts on the body acts about an axis in a horizontal plane.

According to one embodiment herein, a removable support structure, particularly a back-frame or back-pack, is attached to the back of the user body to support the plurality of VSCMGs.

According to one embodiment herein, at least one actuated gimbal and one actuated spin rotor are provided for each of the plurality of the VSCMGs. Particularly, at least one gimbal axis is aligned with a longitudinal axis of the user's body. Particularly, at least one gimbal axis is oriented and controlled so as to prevent undesired gyroscopic effects. The plurality of gimbal and spin actuators are activated to produce control moments on the user's body, particularly to prevent a fall, particularly by slowing down the fall or by bringing the body back to upright posture.

According to one embodiment herein, the portable gyroscopic-assisted system further comprises a plurality of sensors, particularly to detect a pre-fall condition of the user, in order to control the gimbal and the spin actuator to produce the control moment required to prevent a fall, particularly to slow down a fall or reach a desired state, particularly a vertical position.

According to one embodiment herein, the portable gyroscopic-assisted system further comprises a means to provide electrical power to the gyroscopes, particularly by allowing connection to an external power outlet or socket and/or by means of an internal power source, particularly to supply electrical power to the plurality of VSCMGs and/or a means of harvesting energy from the user. Particularly, the internal power source is a rechargeable battery.

According to one embodiment herein, the portable gyroscopic-assisted system further comprises a plurality of flywheels, particularly two or three. By rotating about a gimbal, the spin axis of the flywheels are varied to produce a moment whereby particularly the rotation speed of each gimbal is controlled by a motor on the gimbal.

According to one embodiment herein, the flywheel is used as a reaction wheel to produce a moment by means of the reaction wheel effect. The reaction wheel works on the principle of conservation of angular momentum and the reaction wheel is a spinning mass with a substantial amount of inertia.

According to one embodiment herein, the portable gyroscopic assisted system further comprises a means for braking the flywheel spinning motion, particularly by regenerative braking, particularly by means of a plurality of regenerative brakes that are connected to the flywheel spin axes. This braking function can also be realized by the motors that actuate the flywheel. The brakes generate moments on the user's body and convert kinetic energy stored in the flywheels into electrical energy. Particularly, this electrical energy is used immediately by the gyroscopic-assisted system, and/or it is stored in an additional means for energy storage, particularly a battery or capacitor.

According to one embodiment herein, the portable gyroscopic-assisted system further comprises a controller for tracking a reference moment, particularly in a transverse plane, by using the plurality of the VSCMGs. Particularly, the controller tracks the reference moment by using the reaction wheel effect and/or the gyroscopic effect, particularly by following an optimization procedure.

According to one embodiment herein, the portable gyroscopic-assisted system further comprises a plurality of Direct Current (DC) motors. The plurality of the DC motors—in combination with a plurality of planetary gears—controls speed and torque for the plurality of the VSCMGs.

According to one embodiment herein, a method for stabilizing bipedal gait with gyroscopic assistance is provided. The method comprises the steps of attaching a back frame, particularly a rigid or flexible back frame, to the back of a user. The support structure comprises a plurality of VSCMGs, with at least one actuated gimbal, one flywheel, and one spin motor to actuate the flywheel arranged corresponding to each of the plurality of the VSCMGs, and a plurality of sensors for measuring the current movement of the user, particularly for detecting a fall condition. The plurality of VSCMGs generates moments in order to produce a resultant control moment on the user, particularly to counteract a fall of the user. Particularly, a controlling device provides control signals for the motors, particularly for generating moments by means of the plurality of VSCMGs, particularly when a loss of balance is detected. Particularly, these control signals can be based on a model of a falling user, particularly to bring the user to a desired configuration. Particularly, the final configuration is defined as one in which the user is oriented vertically, particularly with zero velocity.

According to one embodiment herein, the control signals generate a moment vector that lies in the transverse plane of the user to counteract a tilt of the user about a horizontal axis.

According to one embodiment herein, a reaction wheel mode is exploited to compensate for errors instantaneously in the transverse plane.

According to one embodiment herein, the speed of the gimbals is forced to zero when the flywheels approach an undesired configuration, particularly a singular configuration where the spin axis is aligned with the required moment.

According to one embodiment herein, the speed of the gimbals is forced to zero to nullify a plurality of oscillations around the singular configuration.

According to one embodiment herein, the plurality of VSCMGs tracks a desired (reference) moment profile, particularly distributed among the plurality of VSCMGs by means of an optimization process, particularly to gently upright the user.

According to one embodiment herein, the optimization process automatically exploits the reaction wheel effect and/or the gyroscopic effect of the plurality of the VSCMGs.

According to one embodiment herein, a fall detection algorithm is provided, where particularly the fall detection algorithm is based on sensor measurements of the current user motion, particularly of the upper body, particularly measured by inertial, gyroscopic, or magnetic sensors.

FIG. 1 illustrates a schematic design of a portable gyroscopic-assisted system worn by a user to prevent a fall under gait dysfunction, according to one embodiment herein. The embodiment envisions applying moments to a user, particularly to provide balance assistance for those who have difficulty with balancing themselves during normal walking. The portable gyroscopic-assisted system is a wearable accessory that influences the state of balance of bipedal gait, particularly to assist or perturb balance, particularly for training purposes. In other words, the gyroscopic assembly is mounted onto the upper body of a user via a support frame, in this case a backpack 102. The backpack 102 comprises a plurality of gyroscopes 103, particularly such that the gyroscopes 103 are located close to the user's center of mass.

A method for recovering balance using the portable gyroscopic-assisted system is provided. The method comprises mounting a set of gyroscopes 103 in the backpack 102. The backpack 102 is worn by a user. The gyroscopes 103 in the backpack 102 are located close to the user's center of mass. The actuated gyroscope 103 produces moments on the user in different ways that are useful in different situations. When the spinning flywheel is rotated about a gimbal 301 such that the orientation of the flywheel spin axis is changed, a moment about a third, perpendicular axis is produced, according to the gyroscopic effect exploited by conventional CMGs. The angular acceleration of the flywheel about its axis also allows the generation of opposing inertial moments on the connected body. In this case, the gyroscope 103 acts like a reaction wheel that stores and releases kinetic energy. When both effects are used in combination, the system is then called a Variable-Speed Control Moment Gyroscope (VSCMG). However, exploiting the CMG control mode is beneficial to reduce torque and power requirements.

FIG. 2 illustrates the various axis definitions associated with the inertial frame and trunk of the user, according to one embodiment herein. The directions x, y, and z are defined with respect to an inertial frame, with z pointing toward a vertical direction. The directions u, v, and w are defined with respect to the user's trunk, with u pointing in an anterior direction, which is aligned with the x axis if all angles are zero, and w pointing along the user's longitudinal axis. The rotation about the z axis by the angle α maps the x, y, z coordinate system to the x′, y′, z coordinate system. The subsequent rotation about the y′ axis by the angle ζ maps the x′, y′, z coordinate system to the x″, y′, w coordinate system. Finally, the rotation about the w axis by the angle η maps the x″, y′, w coordinate system to the u, v, and w directions.

According to one embodiment herein, the plurality of VSCMGs generates moments on the user's body, particularly for counteracting a fall in any direction. The system of the embodiment herein uses at least two individual VSCMGs, particularly with the gimbals aligned with the longitudinal axis of the user. The plurality of VSCMGs are attached to the user in a manner to allow moments to be transmitted to the user. The moment is transmitted to the user's torso. Particularly, this can be achieved by means of a support structure, particularly a back-frame or backpack. Particularly, the support structure can be based on an orthopedic corset or a back protector that tightly connects the support structure to the user's trunk and/or pelvis. The two actuators are mounted at each VSCMG for controlling the gimbal speed and/or rotation speed of the flywheel. Particularly, the gyroscopic-assisted device generates assistance only after the instant when loss of balance is detected, and otherwise controls gimbal and flywheel speeds such that no undesired moments act on the user in response to user movements.

Whenever two parallel controllers generate input signals on the same system in a closed-loop manner, lack of coordination between them can lead to reduced stability and robustness. Therefore, in the case of balance assistance, the robotic controller should not operate against the user's own controller. In the case of balance training, this can be a desired effect, and destabilization of the user can be a goal. In the case of balance assistance, a particular solution to overcome the problem is to have the robotic device generate only open-loop assistance that is triggered the instant a loss of balance is detected. In the portable gyroscopic-assisted system of the embodiments herein, such a feed-forward moment can be calculated based on a model of the falling user, and the robot can be designed such that the robot uprights the user when the model assumptions are correct. Particularly, the portable gyroscopic-assisted system can be designed such that it only generates a moment that counteracts a pivoting movement about a horizontal axis. The gyroscopic-assisted system does not generate any undesirable moments in response to user movement. Particularly, it does not influence or induce an undesired rotation about any axis of the body. According to one embodiment herein, the gyroscopic-assisted system influences only a rotation of the user about the y′-axis, thereby producing only the necessary moments to prevent a person from falling.

According to one embodiment herein, the fall of the imbalanced user is prevented by bringing back the user's body to a desired final configuration. Particularly, the final configuration is defined as one in which the user's body is upright, particularly with zero velocity. An alternative goal is to slow down the fall to give the user more time to regain control, for example by bringing the swing leg to the front after a stumble.

According to one embodiment herein, the user is considered as an inverted pendulum pivoting around point A as shown in FIG. 1. Math typesetting notations are used, where matrices are represented in boldfaced straight letters, vectors are represented in boldfaced italic letters, and scalars are represented in regular face italic. The motion of the user's trunk is described in terms of Modified Rodrigues Parameters (MRPs). These MRPs are alternatively expressed as functions of the Euler parameters βᵢ (also known as quaternions):

$${σ}_{i} = \frac{{β}_{i}}{1 + {β}_{0}} , i = 1 , 2 , 3 \qquad ( 1 )$$

Also, the motion of the user's trunk is expressible in vector form in terms of the principal rotation angle Φ and the unit principal axis vector êε [symbol] ³:

σ=ê tan(Φ/4) (2)

FIG. 3 illustrates a perspective view of a VSCMG used in a portable gyroscopic-assisted system, according to one embodiment herein. To avoid the unknown ground reaction forces to appear in the equations, the moments are summed up about the pivot point A as shown in FIG. 1, rather than about the center of mass. The equations of motion for the user and the VSCMG assembly are expressed in the user coordinate system as follows.

\dot{H}_{A}=rₛ×(mg)−M_{c} (3)

whereby:

M_{c}=d+D₀\dot{Ω}+A\dot{γ}+B{dot over (\dot{γ} (4)

with rₛε [symbol] ³ denoting the vector from A to the center of mass (CoM), m the mass of the body and gε [symbol] ³ the gravity vector. M_{c}ε [symbol] ³ represents the moment vector produced by the gyroscope assembly. The angular momentum H_{A}ε [symbol] ³ is summed over all body segments. The weight vector mg includes the combined weight of the user and the plurality of the VSCMGs. We assume that the weight of the backpack is readily integrated into the user's body scheme. Therefore, all inertial terms that are caused by the center of mass of the gyroscopes being displaced from the point A, as given by the parallel axis theorem, are considered as part of \dot{H}_{A}. The vector dε [symbol] ³ and the matrices D₀ε [symbol] ^{3×N}, Aε [symbol] ^{3×N} and Bε [symbol] ^{3×N} encode the dependency of moments on the current orientation of the N flywheels:

$$A := ( \begin{matrix}{a}_{1} & … & {a}_{N}\end{matrix} )$$

$${a}_{i} := {g}_{ti} [ {J}_{s} {Ω}_{i} - ( {J}_{s} + {J}_{t} + {J}_{g} ) {ω}_{si} ] + {g}_{si} ( {J}_{s} - {J}_{t} + {J}_{g} ) {ω}_{ti}$$

$${D}_{0} := {J}_{s} ( \begin{matrix}{g}_{s 1} & {g}_{s 2} & {g}_{s 3}\end{matrix} )$$

$$B := {J}_{g} ( \begin{matrix}{g}_{g 1} & {g}_{g 2} & {g}_{g 3}\end{matrix} )$$

$$d := {J}_{s} {\sum }_{i = 1}^{N} {Ω}_{i} ( {g}_{ti} {ω}_{gi} - {g}_{gi} {ω}_{ti} )$$

These vectors are expressed in the user-fixed coordinate system u, v, and w. The \dot{γ}ε [symbol] ^{N×1} and {dot over (\dot{γ}ε [symbol] ^{N×1} represent gimbal speeds and accelerations about g_{gi}, respectively. \dot{Ω}ε [symbol] ^{N×1} denotes accelerations about the spin axis gₛᵢ.

The gimbal torques u_{gi} and spin torques uₛᵢ for the N gyroscopes to produce the given gyroscope motion are:

uₛᵢ=J_{W}_{ₛ}(\dot{Ω}ᵢ+gₛᵢ^{T}\dot{w}+\dot{γ}ᵤwₜᵢ

u_{gi}=J_{g}(g_{gi}^{T}\dot{w}+{dot over (\dot{γ}ᵢ)−(Jₛ−Jₜ)wₛᵢwₜᵢ−J_{W}_{ₛ}Ωᵢwₜᵢ (5)

where the variables Jₛ, J_{g} and Jₜ are the moments of inertia of one combined reaction wheel and gimbal unit about the spin axis, the gimbal axis, and the tangential axis, respectively. The term J_{w}_{ₛ} denotes reaction wheel inertia about the spin axis. The vector ω denotes the angular velocity of the user's trunk (expressed in the u, v, w coordinate system), and the vector components wₛᵢ, w_{gi} and wₜᵢ are the projections onto the respective local axes of the i^{th} gyroscope unit.

The vectors Ωε [symbol] ^{N} and γε [symbol] ^{N} are defined to contain the reaction wheel speeds Ωᵢ and gimbal angles γᵢ, respectively. The vectors uₛε [symbol] ^{N} and u_{g}ε [symbol] ^{N} are defined to denote the corresponding actuator torques uₛᵢ and u_{gi}. With the given desired (reference) profile for M_{c}, a suitable gyroscopic motion and actuator inputs are found. However, the equations are not directly solved for the accelerations \dot{Ω}ᵢ and {dot over (\dot{γ}ᵢ and, thereby, the needed torques according to equation (5), because such a control law relies on excessive gimbal rates.

Instead, the last summand in equation (4) is neglected, which depends on gimbal accelerations, and the gimbal speeds are replaced by reference gimbal speeds \dot{γ}_{ref}:

M_{c,ref}=d+D₀\dot{Ω}+A\dot{γ}_{ref} (6)

where M_{c,ref} is the desired reference moment, which contrasts with the actual moment produced M_{c}. The set of equations is solved for given reference gimbal speeds \dot{γ}_{ref} and reaction wheel accelerations \dot{Ω}. An optimization accounts for the under-determined nature of the equations; a weighted Moore-Penrose Inverse yields minimal reaction wheel accelerations and reference gimbal speeds that fulfill the constraints. These reference gimbal speeds are then tracked using a fast inner loop commanding gimbal accelerations:

{dot over (\dot{γ}=K_{\dot{γ}}(\dot{γ}_{ref}−\dot{γ}) (7)

where K_{\dot{γ}} is an acceleration tracking gain and \dot{γ} is the vector representing actual gimbal speeds.

VSCMGs are often used to control the attitude of a space vehicle in all three dimensions. In such applications, it is important to choose the gimbal directions such that at least two of them are linearly independent in order to avoid singularities. In an embodiment herein, no closed-loop attitude control of the user's body is attempted. Instead, a feed-forward moment profile is generated, whereby the direction of the moment vector is confined to the transverse plane of the user, to purely counteract tilting about the y′-axis. Given that no moments are to be produced about the user's longitudinal axis, it is beneficial to orient the gimbal directions g_{gi} along this longitudinal axis, so

g_{gi}=e_{w},i=1 . . . N (8)

As the feed-forward moment M_{c,ref} is always perpendicular to the gimbal axes, the equations never become singular even though the gimbal axes are collinear.

With the aforesaid assembly, the only moment components along the longitudinal axis are due to the terms d+B{dot over (\dot{γ} in equation (4). These terms lead to fairly large moments on the user when k_{\dot{γ}} is chosen to be large. This is avoided by a proper coordination of the gimbals as shown below. The primary objective of the controller is to track the reference moment in the traverse plane (defined by the span of e_{x″} and e_{y′}) by using the CMG or the reaction wheel effect. The definitions

R_{x″y′}:=(e_{x″}e_{y′})^{T}

Q:=R_{x″y′}/(D₀A)

τ:=R_{x″y′}(M_{c,ref}−d) (9)

enable the control objective in equation (6) to be rewritten as:

$$Q ( \begin{matrix}\dot{Ω} \\ {\dot{γ}}_{ref}\end{matrix} ) = τ \qquad ( 10 )$$

which yields two scalar equations.

There are infinite solutions to equation (10), which provides an opportunity to optimize by defining a cost function that corrects moment tracking error, actuator torques and actuator powers.

The constraints of equation (10) ensure that the moments approach the desired values in the user's transverse plane when the gimbal tracking is fast. However, there is a control error in the direction of all three axes. In the transverse plane, the reaction wheel mode may be used to compensate the errors instantaneously. In the direction of the longitudinal axis, however, only an appropriate coordination of gimbal accelerations can prevent the moments about this axis caused by inertia of the VSCMGs about the gimbal axis. With the definitions

R:=(e_{x″}e_{y′}e_{w})^{T}

C:=−R(D₀BK_{\dot{γ}})

ρ:=R(−M_{c,ref}+d+(A−BK_{\dot{γ}})\dot{γ}) (11)

the vector e_{c} of control errors in the x″, y′, w coordinate system is given by

$$\begin{matrix}{e}_{c} := R ( {M}_{c , ref} - {M}_{c} ) \\ = C ( \begin{matrix}\dot{Ω} \\ {\dot{γ}}_{ref}\end{matrix} ) - ρ\end{matrix} \qquad ( 12 )$$

Furthermore, the gimbal speeds are forced to approach zero once the reaction wheels approach a configuration where the vector gₛᵢ is aligned with the required moment vector (along the y′-axis). This avoids oscillations around the configuration where no desirable moments are produced by the CMG effect. A small additional term also corrects a deviation in the angular speeds of the reaction wheels from a nominal value. Combining all these terms, the cost function J is:

$$J := {e}_{c}^{T} {W}_{e} {e}_{c} + {\sum }_{i = 1}^{N} [ ( {w}_{su} + {w}_{sp} {Ω}_{i}^{2} ) {u}_{si}^{2} + ( {w}_{gu} + {w}_{gp} {\dot{γ}}_{i}^{2} ) {u}_{gi}^{2} ] + {\sum }_{i = 1}^{N} [ {w}_{{\dot{γ}}_{i}} {\dot{γ}}_{i}^{2} + {{w}_{Ω} ( {Ω}_{ref} - {Ω}_{i} )}^{2} ] \qquad ( 13 )$$

All the weighting factors are constant, except for w_{\dot{γ}i}, which corrects the gimbal speeds. The terms wₛᵤ and wₛₚ are the weighting factors for the spin axis torques and speeds, respectively, while w_{gu} and wₛₚ are the gimbal axis counterparts. The weights w_{\dot{γ}i} depend on the proximity of the respective spin axis to the y′-axis, and constant positive values a₀ and a₁.

w_{\dot{γ}i}:=a₀+a₁(−2βᵢ³+3βᵢ²), with βᵢ:=|e_{y′}^{T}gₛᵢ| (14)

The third-degree polynomial ensures a smooth transition between the extreme values a₀ and a₀+a₁. This way, the closer the VSCMGs come to aligning the spin axis with the needed moment vector (in a CMG, this is the singular configuration), the more the reaction wheel mode is employed.

Assuming that user angular acceleration \dot{w} is negligible, the actuator torques u_{g} and uₛ are rewritten as linear functions of the reaction wheel accelerations \dot{Ω} and the gimbal reference velocities \dot{γ}_{ref}, using equation (5) and (7). Then the minimization of J reduces to a linear least squares with the linear constraints (10). Therefore, the global minimum can be calculated analytically and little computational power is needed for the calculation in each time step. Following this control law/equation, the moment component in the transverse plane will asymptotically approach the desired feed-forward (reference) moment vector M_{c,ref}. The feedback gain K_{\dot{γ}} controls how fast these dynamics are. In this process, the undesired moment components about the user's longitudinal axis, caused by gimbal inertias, are kept small.

### Simulation Study

For a first proof of concept, a simulation is conducted for a worst-case scenario: a person does not apply any balance-recovering actions, but instead falls rigidly, with the hip and knee joint stiff and no moments applied about the ankles. Then, the rate of change of angular momentum is given by:

\dot{H}_{A}=I_{A}\dot{w}+w×(I_{A}w) (15)

where the inertia tensor I_{A} is constant in the user frame. In equation (15), the inertia tensor is calculated by assuming that the user is a cylinder with homogeneous mass distribution, rotating about the fixed pivot point A. The following assumptions are also considered: The mass of the user is 70 kg and the height h is 1.7 m. For the initial orientation of the user, α=η=0° is chosen, and an initial inclination of the user of ζ=10° from the vertical, with zero initial velocity assumed. The task of the device is to orient the user vertically.

For the feed-forward controller, a feed-forward, trapezoidal moment profile is applied. The ramp speeds were ±2800 Nm/s, with a maximum moment of 280 Nm held for 0.0937 s.

The following assumptions are also made as a numerical example: N=3 VSCMGs, each with a mass of 3 kg, although a realization for elderly subjects would likely be lighter. Furthermore, 2.5 kg of each VSCMG is hypothesized for use as rotating mass in a given suitable design and an additional 0.5 kg results from a non-functional actuator and structural mass. Furthermore, considering the bulkiness of the gyroscopic assembly, the disc radius is limited to 0.15 m. Another assumption is made, that the mass of the reaction wheel is primarily concentrated on an outer ring, so the moment of inertia is maximized.

The control parameters and weights are chosen as:
K_{\dot{γ}}=500 s⁻¹
Ω_{ref}=9000 rev/min
wₛₚ=w_{gp}=1 W⁻²
wₛᵤ=w_{gp}=1 N⁻²
w_{Ω}=10 s²
a₀=100, a₁=1000
Wₑ=1000 N⁻²I^{3×3}
   In the simulation, the VSCMGs start at the nominal configuration of γ₁=−π/3, γ₂=π/3, γ₃=π. With these initial conditions, the combined equations of motion (3) of the VSCMGs and the user are numerically solved by an explicit Runge-Kutta algorithm (MATLAB ode45).

FIG. 4 illustrates a chart indicating spin and gimbal actuator torques generated in a simulation of a portable gyroscopic-assisted system, according to one embodiment herein. The graphical chart indicates the value of torques (in Nm) generated with respect to time (in seconds). The relationship between the spin and the gimbal torque is indicated in the chart. The uₛ₁, uₛ₂, uₛ₃ represent spin torque (shown in thin lines) and u_{g1}, u_{g2}, u_{g3} represent gimbal torque (shown in thick lines). For gently uprighting the user, the optimization automatically exploits both the CMG and the reaction wheel effects.

FIG. 5 illustrates a chart indicating reference moments and actual moments in a portable gyroscopic-assisted system, according to one embodiment herein. The graphical chart indicates the values of the reference and actual moment components in the x″, y′, w directions (in Nm) with respect to time (in seconds). The gyroscopic action tracks the desired (reference) moment profile exactly as the reference and actual moments are almost coincident. The reaction wheel moments translate to uprighting moments by a direct projection of the vector onto the y′-axis. By comparing FIG. 4 and FIG. 5, it is evident that the contribution of the reaction wheel mode to moment tracking is much smaller than the CMG contribution over the entire duration. This illustrates that the much lower gimbal actuator torques u_{gi} still dominate in tracking the desired (reference) moment profile. This is a well-known effect and confirms the preferability of using the CMG mode whenever possible. The third flywheel is in a particularly ideal configuration to contribute, with its spin axis orthogonal to the direction of the desired (reference) moment vector (at 90°). The first gyroscope contributes the least over the entire time course because its spin axis starts off being almost aligned with the y′-axis.

FIG. 6 illustrates a chart indicating the values of spin and gimbal actuator powers generated in a simulation of a portable gyroscopic-assisted system, according to one embodiment herein. The chart discloses a relationship between the spin and gimbal actuator power (in W) with respect to time (in seconds). In a practical model, torque, speed, and energy requirements could be achieved by using existing commercially available batteries and DC motors in combination with planetary gears. By employing energy harvesting means such as regenerative braking, the energy requirements are further reduced and the efficiency is increased.

FIG. 7 illustrates a chart indicating the values of gimbal angles generated in a simulation of a portable gyroscopic-assisted system, according to one embodiment herein. FIG. 7 is a graphical plot of gimbal rotations based on the same simulation experiment, according to one embodiment herein. The graph shows angles (in degrees) plotted against time (in seconds). The graphical plot explains the variation of gimbal angles γ₁, γ₂, γ₃ with respect to time.

FIG. 8 illustrates a chart indicating the spinning speeds of the reaction wheels in a simulation of a portable gyroscopic-assisted system with respect to time, according to one embodiment herein. The graph shows speeds (in rev/min) plotted against time (in seconds). The graph is plotted for the three different flywheel speeds Ω₁, Ω₂ and Ω₃ of the three gyroscopes.

FIG. 9 illustrates a chart indicating the angular speed of the user with respect to time based on a simulation of a portable gyroscopic-assisted system, according to one embodiment herein. The graph shows the user motion in MRPs plotted against time (in seconds). The graph describes gentle uprighting of the user body.

FIG. 10 illustrates a cross-section perspective view of a portable gyroscopic-assisted system, according to one embodiment herein. With respect to FIG. 10, each of the plurality of the VSCMGs has a flywheel 1003 mounted on a gimbal frame 1005 provided with a gimbal motor 1002 and an angle sensor 1001. The flywheel 1003 is rotated with a motor 1004 that incorporates a velocity sensor. The gimbal and the spin rotor are activated to prevent any undesired gyroscopic effect and/or produce desired (reference) control moments on the user, particularly to bring the body into a desired configuration, particularly an upright posture.

The gyroscopes in the backpack are located close to the center of mass of the user's body. The actuated gyroscope can produce the moments in different ways, which are useful in different situations. When the spinning flywheel 1003 is rotated about a gimbal such that the orientation of the flywheel spin axis is changed, a moment about a third, perpendicular axis is produced. This is the effect exploited by conventional CMGs. The angular acceleration of the flywheel about its axis also allows the generation of opposing inertial moments on the connected body. In this case, the gyroscope acts like a reaction wheel that stores and releases kinetic energy. When both effects are used in combination, the system is called a Variable-Speed Control Moment Gyroscope (VSCMG). This includes the case where the gyroscopes are used only as conventional control moment gyroscopes (CMGs), in which case the reaction wheel effect is not exploited.

The simulation results indicate that the portable gyroscopic-assisted system prevents falls, for the assumed falling angle of 10° from vertical for a simplistic user model. The current simulation assumed that the device is designed and programmed to completely upright the user. However, an alternative goal could be that the device only reduces the speed of falling, resulting in more time for the user to react. As elderly fallers have longer reaction times compared to non-fallers, such short-duration balance assistance could also be beneficial, bridging the gap of the first milliseconds before the subject is able to react. A further alternative goal could be to perturb or resist movements of a subject (instead of assisting balance), particularly in order to challenge balance responses during training, particularly for rehabilitation.

According to one embodiment herein, a suitable fall detection algorithm is adopted. The fall detection algorithm is based on sensor data on user motion, particularly using sensors on the gyroscopes and/or a plurality of additional sensors mounted on the support structure or directly on the user's body. Particularly, these sensors could be a plurality of accelerometers, gyroscopes, joint angle sensors, or magnetometers.

According to one embodiment herein, a suitable control algorithm is adopted to control the moment vector that acts on the user. Particularly, the algorithm distributes the control moment vector among the plurality of gyroscopes by means of an optimization, particularly using a cost function that favors exploitation of the control moment gyroscope effect over the reaction wheel effect.

According to one embodiment herein, the portable gyroscopic-assisted system is also applicable for balancing a user based on physiological or artificial reflexes, such as stumbling corrective reactions. Particularly, reflexive reactions of the user could be measured and serve as fall indicators to trigger a supportive reaction of the device, or the device could offer artificial reflexes, which replace the current model-based control strategy. Particularly, the artificial reflexes could be similar to control approaches that have been suggested for walking models and powered leg prosthetics.

The various embodiments herein provide a gyroscopic-assisted system for automatically balancing user gait dysfunctions and preventing injuries caused by falls. The gyroscopic-assisted system uses minimalistic robotic technology and particularly focuses on stabilizing users' imbalance. The gyroscopic-assisted system is a task-specific device that is novel in its combination of portability and simplicity. The invention is unique because it provides balance assistance without the unnecessary bulk of weight-bearing aids, although it could be combined with them if needed. The gyroscopic-assisted system is a lightweight balance prosthetic that is optimized for easy, daily wearing because it decouples balance assistance from weight-bearing assistance. A portable solution integrated within a backpack is a simple system and provides a flexible solution for the daily life of a person with balance disorders, thereby reducing the risk of falls and improving quality of life. The gyroscopic-assisted system also augments the natural abilities of able-bodied users in challenging environments (e.g. factory manual labor, sports like snowboarding, applications in outer space or underwater etc.).

The foregoing description of the specific embodiments will so fully reveal the general nature of the embodiments herein that others can, by applying current knowledge, readily modify and/or adapt them for various applications. Such specific embodiments are possible without departing from the generic concept, and, therefore, such adaptations and modifications should be, and are intended to be, comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments, which, as a matter of language, might be said to fall there between.

What is claimed is:

1. A portable gyroscopic-assisted system, the system comprising:
a plurality of gyroscopes attached to a user to transmit a control moment on the user, particularly to influence orientation of the user, wherein the plurality of gyroscopes comprises an assembly of two or more control moment gyroscopes (CMGs) or variable-speed control moment gyroscopes (VSCMGs).

2. The system according to claim 1, wherein each of the plurality of CMGs or VSCMGs comprises a spinning mass with a substantial amount of inertia, and wherein the spinning mass is a flywheel and wherein the direction of the spin axis of the flywheel is changed by a first actuator by rotating the flywheel about a gimbal axis, particularly to produce a moment through a gyroscopic effect, and wherein particularly the first actuator is an electric motor.

3. The system according to claim 2, wherein each of the plurality of CMGs or VSCMGs comprises a second actuator that provides a torque that influences rotational speed of the flywheel about the spin axis, particularly to maintain constant speed and/or to exploit a reaction wheel effect, and wherein particularly the second actuator is an electric motor.

4. The system according to claim 1, wherein the control moment prevents or slows down a fall of the user.

5. The system according to claim 1, wherein the plurality of gyroscopes is placed close to the center of mass of the user.

6. The system according to claim 1, wherein a removable support structure, particularly a flexible or rigid back-frame or backpack, is attached to the back of the user to support the CMGs or the VSCMGs.

7. The system according to claim 2 or 3, and wherein said first and/or said second actuator is/are controlled so as to cancel any undesired gyroscopic effects caused by a movement of the user.

8. The system according to claim 1, wherein at least one gimbal axis is aligned with the longitudinal axis of the user.

9. The system according to claim 1, wherein said system further comprises a plurality of sensors, particularly to detect a pre-fall condition of the user, to control the gimbal actuators and/or the spin actuators to produce a control moment, particularly to prevent or slow down a fall.

10. The system according to claim 1, wherein said system further comprises a means for providing energy to the plurality of CMGs or VSCMGs, by allowing a connection to an external power source or by means of an internal energy supply unit, and wherein the energy is provided in the form of electrical energy, and wherein the internal energy supply unit is a rechargeable battery.

11. The system according to claim 1, wherein said system further comprises a brake provided at the spin axis of the flywheel for braking the flywheel, to generate moments on the user through the reaction wheel effect, and wherein the brake converts kinetic energy of the flywheel into heat and/or electric energy, and wherein particularly the brake is regenerative and the electric energy is used immediately by actuators other than said second actuator or stored for later use in a rechargeable battery or a capacitor.

12. The system according to claim 1, wherein said system further comprises a controller for tracking a reference moment vector by using the plurality of CMGs or VSCMGs, and wherein the controller tracks the reference moment by using the gyroscopic effect and/or the reaction wheel effect.

13. The system according to claim 2 or 3 wherein the said first and/or said second actuator are/is a Direct Current (DC) motor(s), in combination with a plurality of transmissions, particularly planetary gears.

14. A method for stabilizing user gait with gyroscopic assistance, the method comprising the steps of:
attaching a support structure to the back of the user, and wherein the support structure comprises a plurality of control moment gyroscopes (CMGs) or variable-speed control moment gyroscopes (VSCMGs), and wherein each of the plurality of CMGs or VSCMGs contains a flywheel that is gimbaled and actuated by at least a first actuator, and wherein a plurality of sensors for detecting a fall condition is connected to the user, and wherein;
moments are generated by means of the plurality of CMGs or VSCMGs, to produce a net control moment on the user, wherein moments are controlled based on a model of the user and/or a model of falling, in order to bring the user to a stable configuration or help the user get to a stable configuration.

15. The method according to claim 14, further comprising; confining the net control moment to a transverse plane of the user to counteract tilting of the user.

16. The method according to claim 14, exploiting a reaction wheel mode to compensate for errors instantaneously.

17. The method according to claim 14, further comprising; forcing speed of at least one of the said gimbals of the plurality of CMGs or VSCMGs to zero before said gimbal approaches a singular configuration and wherein the singular configuration corresponds to a configuration in which the flywheel spin axis direction is aligned with the desired net control moment vector.

18. The method according to claim 14 wherein the plurality of CMGs or VSCMGs track a desired net control moment by an optimization process.

19. The method according to claim 18, wherein the optimization process automatically exploits a gyroscopic effect and a reaction wheel effect in the plurality of CMGs or VSCMGs.

20. The method according to claim 14 wherein a fall detection algorithm is provided for detecting a destabilization of the user.
